(19) United States
(12) Patent Application Publication
(10) Pub. No.: US 2018/0186495 A1
(43) Pub. Date: Jul. 5, 2018

(54) DEVICE AND METHOD FOR APPLYING GLUE IN A RETURNLESS MANNER

(71) Applicant: KRONES AG, Neutraubling (DE)

(72) Inventor: Volker KRONSEDER, Neutraubling (DE)

(21) Appl. No.: 15/738,541

(22) PCT Filed: Apr. 13, 2016
(86) PCT No.: PCT/EP2016/058046

§ 371 Date: Dec. 20, 2017

(30) Foreign Application Priority Data
Jun. 30, 2015 (DE) 102015212198.4

(51) Int. Cl. B65C 9/22; B05C 11/10; B05C 11/11

(52) U.S. Cl. CPC B65C 9/2269; B05C 11/11; B05C 11/1042; B05C 11/1013

(57) ABSTRACT

A labeling method and a labeling device for applying labels onto containers, said device comprising a gluing unit for applying glue to the labels, in particular with a glue roller, a storage container for storing glue, which container has a device for removing glue from the storage container, said device comprising a deformation unit which is designed such that glue is pressed out of the storage container by deforming the storage container by means of the deformation device.

### FIELD OF THE INVENTION

The present invention relates to a device and a method for precisely applying glue on labels in a labeling device for containers, in particular for cans, glass bottles, PET bottles or the like.

### PRIOR ART

Labeling machines are used in the beverage processing industry in order to apply continuously labels to consistently fed articles or containers with high performance. Thereby, the containers may be cans, glass bottles, PET bottles or the like. In addition to self-adhesive labels, also labels are known onto which initially glue is applied for subsequently applying the labels provided with glue onto the containers. Appropriate glue, for example, is applied onto the rear sides of the labels via a gluing unit by means of a glue roller. This may occur directly by applying the glue by means of the glue roller to the labels passing by means of a vacuum cylinder. However, it may also occur indirectly by initially transferring the glue by means of a glue roller to the curved adhesive surface by extraction elements which are moved past the glue roller in an oscillating or rotating manner, so-called pallets which for their part remove separately the labels from a label stack, whereby during removing, the labels are provided on the rear side with the glue that beforehand has been transferred. The now glued labels are subsequently transferred to a rotating gripper cylinder or the like, from where they are transmitted to the containers.

In both cases, the required glue initially has to be transferred by a storage container for glue to the glue roller. For this, the glue is usually pumped from the storage container to a glue application unit by means of a pump and is applied thereto over the entire axial extension of the glue roller.

Document DE 3022040 A1, for example, describes a glue roller to which a glue application element and an adjustable glue scraper are assigned. Thereby, the glue drained from the storage container by means of the glue scraper is transferred to the glue roller. Regularly, the glue scraper is configured pivotedly and abuts tangentially the glue roller in axial direction of the glue roller. The positioning of the glue scraper at the glue roller, thereby, is of great importance for an optimal labeling result. During applying the glue on the glue roller, a so-called glue string is formed.

In this embodiment, it is a problem that in the event of an operation stoppage of the labeling machine the glue string remaining at the glue roller may dry out and sometimes may be very difficult to be removed. Furthermore, regarding such a system, there is the risk that due to contacting the ambient air, in particular due to contacting the atmospheric oxygen changes its chemical structure and/or composition. Furthermore, regarding the known systems, the glue string extends over the entire height, i.e. extension of the glue roller in axial direction so that the applied glue is not accommodated in its full surface by the generally smaller label or pallet. The glue which is not accommodated, on the other hand, can become touch dry at the glue roller or change its characteristics.

Thus, the objective technical problem of the present invention is to provide a gluing unit for a labeling device in which the glue preferably is applied only if it is needed. In addition, it is an object of the present invention that different operation modes of the labeling device as e.g. a labeling mode, a sleep mode, cleaning mode, etc., may be adjusted particularly easily and preferably. Broadly, the objective technical problem of the present invention is to reduce the glue consumption of the labeling device and to prolong its service life.

### DESCRIPTION OF THE INVENTION

The above mentioned objective technical problems are solved by a labeling device for applying labels onto containers comprising a gluing unit for applying glue to the labels, in particular with a glue roller and a storage container for storing glue which container has a device for removing glue from the storage container, said device comprising a deformation unit which is designed such that glue is pressed out of the storage container by deforming the storage container by means of the deformation device. Thereby, the storage container may be closed in particular except for an opening through which the glue is pressed out. As mentioned, the gluing unit may be configured such that the labeling occurs directly, i.e. by means of direct applying of glue on the rear side of the labels or indirectly, i.e. via applying glue on pallets before accommodating the labels. For this, the gluing unit may in particular comprise a glue roller. Alternatively, applying glue to the labels or pallets may also occur by means of a glue printer as described below.

The labeling device for applying labels on containers may generally be an arbitrary labeling device known from the prior art which has a glue roller or glue printer for applying the glue on the labels to be applied as described above directly or indirectly. As mentioned, the containers may be cans, glass bottles, plastic bottles or the like. In particular one or more of the known elements such as a container feed, a container table, a container removal, an infeed worm, a labeling assembly with one or two label tape rolls, label feed, cutting unit, vacuum roller and vacuum or gripper cylinder or a labeling assembly with a label box, pallet carousel or removal element carriers, corresponding pallets or removal elements including possibly required control curve, and gripper cylinder or the like may be part of the labeling device. The mentioned elements are well known in the prior art and are therefore not described in detail here. In addition, exemplary embodiments of such labeling devices are described in more detail in connection with the Figures.

It is only required that the labeling device according to the invention comprises a principally known glue roller or the below described glue printer, a storage container for storing glue and the above mentioned device for removing glue from the storage container by deforming the storage container. For this, the device comprises a deformation device which according to the invention is configured such that the glue is pressed out of the storage container by deforming the storage container by means of the deformation device. Thus, for removing the glue from the storage container a glue pump which otherwise is usual is not explicitly required. Further, the storage container does not comprise such a pump or is configured as a part of such a pump. The deformation of the storage container thereby occurs by in particular mechanical application of the deformation device on the storage container. Thereby, the storage container and the deformation device can be provided as separate units, wherein the storage container in addition can be exchangeable, in particular provided in the form of a non-returnable container. The deformation according to the invention occurs such that thereby the internal pressure of the glue in the container increases whereby glue is pressed out with a desired pressure and/or a desired speed through an opening of the storage container.

The opening of the storage container can be linked with a connection of the device for removing of glue, in particular detachably, for example by means of a screw top to which a transport line can be connected for transporting the glue removed from the storage container to an applying unit, for example the above described glue scraper or a glue strip with a glue nozzle as it is principally known which applies the glue to the glue roller. Alternatively, the transport line can provide a glue printer with glue which can print a variable glue image on the pallets. Further elements known from the prior art, as for example control valves, drive units or the like can also be used for example in order to control the quantity of the transported glue or to operate the glue roller. Since such elements are known in the prior art, it is dispensed with a detailed description here.

As mentioned above, instead of the glue roller, also a controllable glue printer for applying the glue to the pallets or the rear sides of the labels can be provided. Thereby, the glue in a variable glue image is directly applied to a contact surface of the pallets or a glue-applying surface of the labels. Low viscosity glue, glues with a viscosity of between 600 and 8000 mPa s and casein or dispersion glues with an optimal working temperature of between 18° C. and 40° C. can e.g. be used as glue. A glue image is to be understood here and in the following as being a glue applying pattern which is applied to the contact surface or the glue applying surface. Thereby, the glue applying pattern may consist of an arbitrary two-dimensional arrangement of glue points, glue lines and/or glue surfaces. The applying of glue must not necessarily occur flatly since glue points or glue lines applied to the contact surface or the glue applying surface by pressing on the label during accommodating the same from a label supply unit or during transferring the same to the container to be labeled are set out and can merge with one another in this manner. Further, only parts of the contact surface or the glue applying surface can be provided with glue in order to achieve that the labels are held in place on the container surface in a sufficiently strong manner.

By using a controllable glue printer, the printed glue image can be varied according to the invention. For this, the glue printer can comprise one or more controllable glue nozzles by means of which the glue is sprayed drop by drop or as continuous jet under pressure on the glue applying surface. The control of the glue printer can thereby comprise the control of the one or more glue nozzles in respect of the escape of glue and/or the alignment of the glue nozzles or the entire glue printer. The applying of glue, for example, can also occur in a one-jet process by a two-dimensional movement of the glue nozzle and/or the pallet or the label to one another. The control of the glue printer, thus, can comprise the control of the glue nozzles and the control of this movement. The same naturally applies when using a multiple-jet glue printer. The glue printer furthermore in particular can apply the glue image according to the inkjet process on the contact surface or the glue applying surface. The application with a continuous jet as well as according to the drop on demand principle are possible.

Using a glue printer according to the inkjet process, the pressure established by the deforming the storage container may be at least partly used for operating the glue nozzles so that an additional glue pump may be dispensed with. If, however, higher glue pressures are required, an additional glue pump or a pressure booster pump with a media pressure of 30 to 90 bar can be provided. The additional use of a speed mixer or a twin-screw extruder which vents and mixes the glue once again is also conceivable.

The deformation unit and the storage container according to the invention are configured such that the storage container may be deformed by means of the deformation unit and glue may be pressed out of the storage container by this deformation. Thereby, a plurality of different configurations of the storage container and correspondingly, the deformation unit are conceivable (see below). Thereby, storage containers can be used which in their entirety are configured in a deformable manner. Conversely, storage containers may be used from which only a part is configured in a deformable manner. This part may be part of a wall element, a ceiling element and/or a bottom element of the container which generally is closed except for the opening for removing the glue but it may also be an element being structurally contrasted from the rest of the container wall which, for example, may be inserted into an interior of the container similar to a spraying device. The deformation of the storage container, thus, broadly may also comprise the switching of an otherwise rigid wall element of the storage container. Strictly speaking, it may, however, also be interpreted as being a real deformation of a wall element vis-à-vis the original form of the container in the state of being filled with glue. The deformation of the storage container, for example, may occur by impressing, squeezing, pushing together, buckling or a similar treatment of one or several parts of the storage container.

The glue may be hot glue, UV glue, cold glue or any other adhesive. Especially preferable, the device according to the invention may be used for applying cold glues, in particular viscous cold glues as, for example, casein glue or dextrin glue. Alternatively, the device may also be used for applying dispersion glue. The device according to the invention may be used for low viscosity glue, glue with a viscosity of between 600 and 80000 mPa as well as for casein or dispersion glue with an optimal working temperature of 18° C. to 40° C.

According to an embodiment, the deformation unit may be configured such that by applying of the deformation unit on the storage container, the accommodation volume of the storage container for glue is reduced. In general, before its operation in the labeling device, the storage container is filled with glue such that its accommodation volume is completely filled with glue or up to a certain level. For example, storage containers in the form of filled non-returnable containers can be provided which are connected to the removing device of the labeling device and are used as long as they are essentially drained completely, for example, except for 5% of the original filling quantity. By a simple exchange of the drained storage container by a new filled storage container, thus, the service life of the labeling device can be extended.

The application of the deformation device on the storage container as explained above may be of mechanical type. In particular, the accommodation space may be reduced by direct mechanical application of the deformation device on the storage container, in particular on at least one part of the outer wall of the storage container. Alternatively, as mentioned above, by direct mechanical application on a movable part of the outer wall of the storage container, a reduction of the accommodation volume may be achieved. By the achieved reduction of the accommodation volume, the pressure of the glue located in the accommodation volume which, thus, is pressed out of the accommodation volume through an opening provided therefor. Thereby, the reduction of the accommodation volume, for example, can occur similar to compressing a tube, a can or folding bellows but also similar to draining a spraying device. Depending on the configuration of the deformation device and the storage container, a plurality of alternative embodiments for reducing the accommodation volume is conceivable. The removal of the glue from the storage container, however, occurs without providing a pump but by the pressure built-up by the reduction of the accommodation volume. Thus, the labeling device according to the invention compared to conventional labeling devices may be simplified and the maintenance costs can be reduced.

According to a specific embodiment, the deformation device may at least comprise one deformation element which can be brought into contact with the storage container and which can be configured such that the storage container and the deformation element are movable relatively to each other, whereby due to a relative movement of the deformation element and the storage container, the accommodation volume of the storage container for glue is reduced. The relative movement may thereby occur by moving the deformation element alone, the storage container alone or by simultaneously moving both. Thereby, due to the relative movement, in particular, a deformation element spatially spaced apart from the storage container, for example for exchanging the storage container, may initially brought into mechanical contact with the storage container, in particular with a part of the outer wall or a movable part of the storage container. In case of continuous relative movement, the storage container is increasingly deformed so that the contained glue is pressed out of the opening. The storage container and in particular its outer wall, may thereby be configured such that also under the mechanical application, it does not break and, thus, also further openings do not occur through which the glue could escape uncontrollably. The deformation device may also comprise two or more deformation elements which can be brought into contact with the storage container. For example, the storage container can be arranged between two punches or rollers facing each other from which at least one is movable towards the other, respectively. Alternatively, two rollers or wedges facing each other may be provided between which the storage container similar to a tube to be expressed is pulled or pushed through. The relative movement, thus, must not necessarily lead to a change in distance between storage container and deformation element. Rolling out a storage container by longitudinal displacement is also conceivable. Other embodiments, for example, in form of a punch-shaped movable piston with corresponding anvil as counterpart for deforming a storage container which is arranged in between, are conceivable. Individual not restricting embodiments are described in detail in the following in connection with the Figures.

According to a further embodiment, the deformation device may comprise a controllable and/or adjustable drive unit which is configured such that it causes the movement of the deformation element and/or the storage container. For example, the drive unit may be a linear motor, in particular a motor with a spindle drive. Alternatively, pneumatic or hydraulic drives are conceivable. For the movement of the deformation element and/or the storage container, a joint drive or separate drives can be provided. Separate drives for several deformation elements can also be provided. In particular, separate drives may be controlled and/or adjusted independent from one another. For this, for example, servomotors can be used. The deformation element/s and/or the storage container may be provided with appropriate supports at which the drive/s effectively acts/act for producing the desired movement.

According to a special embodiment, the deformation device can further comprise a programmable logic controlling and/or adjusting unit which is configured to control and/or adjust the drive unit depending on at least one control parameter. The at least one control parameter may in particular originate from the group which is formed by the following parameters: the type of the labels to be applied with glue, the number of the labels to be applied with glue per time unit, the variety of the used glue, the temperature of the used glue, the ambient temperature of the glue roller or the glue printer and the surface of the labels to be applied with glue. Programmable logic controlling and/or adjusting units are well-known in the prior art, wherefore it is dispensed with a detailed description. It is clear that known elements as a processor unit, a reproducing assembly, as for example a monitor or a touchscreen, an input unit as for example a keyboard or a touchscreen, a storage unit, in particular for storing one or more of the above mentioned parameters in the form of a type management, and the like may be part of the mentioned programmable logic controlling and/or adjusting unit.

Some of the control parameters as, for example, the type of the labels to be applied with glue, the variety of the used glue or the surface of the labels to be applied with glue can be predetermined in the form of a type management by reading them out from the above mentioned storage unit in the event of a product change. Other control parameters, as for example the number of the labels to be applied with glue per time unit, the temperature of the used glue or the ambient temperature of the glue roller or the glue printer can be determined by corresponding sensors, e. g. optical sensors for measuring the flow capacity at containers or temperature sensor and can be used for controlling the drive unit. The controlling and/or adjusting unit, for example, can control the drive unit depending on the measured flow capacity such that exactly the quantity of glue is pressed out of the storage that is required for applying the corresponding number of labels with glue. Further control parameters as for example a viscosity of the glue or a surface quality of the containers to be labeled can be taken into consideration during controlling and/or adjusting the drive unit. The type of the labels to be applied with glue can comprise also the size and the format of the labels besides the material of the labels. Labels may, for example be designed as wrap-around labels or front- and rear side labels. As well, body labels and neck labels for bottles to be labeled may be provided. The glue type as described above can e.g. be given by a casein glue, a dextrin glue or a dispersion glue. The ambient temperature of the roller has an influence on the adhesion properties of the glue on the label and, thus, on the amount of the glue from the label or the pallet removed from the glue roller.

The controlling and/or adjusting of the drive unit of the deformation device allows that just as much glue is removed from the glue storage container and transferred to the glue roller or the glue printer as required for applying the labels to be applied with glue. Thereby, a surplus of glue at the glue roller and the running down connected therewith and/or touching dry of glue at the glue roller can be avoided. In particular, it can be dispensed with a return flow of the surplus of glue, whereby the entire gluing unit can be simplified.

According to an embodiment, the labeling device can further comprise a housing for accommodating the storage container, wherein the housing in particular can be formed such that it encompasses a part of the outer surface of the storage container in a sleeve-like manner. Thereby, the housing can be formed such that the storage container filled with glue is partly encompassed from the housing in the form of an abutting sleeve. The form of the housing can be predetermined depending on the form of the storage container and the focused deformation process such that the sleeve-like housing stabilizes the part of the storage container encompassed by it during the deformation process. For example, the part opposing a movable deformation element, e.g. a punch of the outer surface of the storage container can be accommodated from a correspondingly formed housing so that this part of the storage container, even if it was per se unstable vis-à-vis the acting forces due to the used material of a wall of the storage container, is stabilized by the housing. In other words, the housing acts as a mold, for example as a half mold in order to maintain the shape of the part of the outer surface of the storage container during the deformation. Thereby, at least the corresponding part of the wall of the storage container can be configured with a lower material thickness and/or more cost-effective materials. In particular, by the housing, a bursting or breaking of the corresponding part of the storage container due to the predominant pressure in the accommodation volume is avoided. In addition, the housing prevents that the storage container evades the deformation by the deformation element and that thereby the desired pressure in the glue is not established. As well, the housing allows a nearly complete draining of the storage container with a respective complementary configuration of the deformation element. The housing, therefore, in particular can be provided as counter element of the deformation unit to the movable deformation element.

According to an embodiment, the labeling device can further comprise a heating device and/or a cooling device which is configured such that the storage container can be heated and/or cooled. Additionally or alternatively, the heating and/or cooling device can be configured such that the above mentioned transport line for the glue and/or the above mentioned glue application unit can be heated and/or cooled. Cooling is possibly necessary for processing cold glues in very hot climates since their viscosity otherwise may be too low for an efficient and proper processing due to the ambient temperature. Conversely thereto, heating is required for keeping the glue to be processed in cold climates at the desired working temperature. The heating and/or cooling device can be configured such that the storage container can be directly heated and/or cooled, for example via a contact surface with the storage container or, however, indirectly heated and/or cooled, e.g. by tempering the ambient air of the storage container. In particular, the aforementioned housing may be configured as being heatable and/or coolable. Alternatively, the interior of the below described enclosure can be tempered by means of the heating and/or cooling device. The heating and/or cooling device can be configured controllably and/or adjustably, wherein the controlling and/or adjusting may occur in particular via the above described programmable logic controlling and/or adjusting unit. Correspondingly, also here, at least one temperature sensor for measuring the temperature of the storage container, the transport line, the glue application unit, the interior of the enclosure and/or the glue can be provided. The controlling of the heating and/or cooling unit in this case may occur such that the glue is always processed with the optimal working temperature depending on the used glue variety.

As mentioned, the labeling device can further comprise an enclosure which is arranged and configured such that it completely encompasses the deformation device and the storage container. For example, a cabinet-like enclosure may be provided in the interior of which the deformation device and the storage container are placed. The enclosure, thus, can be opened, for example, for exchanging an empty storage container. In the closed state, the enclosure, however, forms a nearly hermetically sealed space which can be tempered to the above mentioned desired working temperature of the glue. Additionally, the enclosure and the deformation device may form a movable module which can be easily refitted in existing labeling devices.

According to a further embodiment, the above mentioned connection of the device for removing glue from the storage container can be arranged such that it is linkable from above with the opening of the storage container. The terms above and below, here and in the following, are to be understood with reference to the predominant gravity. By linking the connection from above with the opening of the storage container, and by in particular arranging the entire accommodation volume of the storage container below the connection, it may be achieved that the internal pressure of the glue generated by the deformation unit corresponds to the glue emitted through the opening. In particular, there does not sustain any pressure on the opening due to the weight of the glue without any force application. Thereby, the pressure of the glue removed through the transport line can be precisely controlled.

The present invention also provides a storage container for the use in a labeling device according to one of the above described embodiments which is configured such that it is deformable by applying the deformation unit. The storage container in its simplest form can comprise an outer wall encompassing an accommodation volume made of a deformable material, for example a plastic that can be deformed, in particular polyethylene terephthalate (PET), polyethylene (PE), high density polyethylene (HDPE), or the like with an opening which preferably can be locked by a screw plug. A coating, in particular of PET containers with so-called barrier layers, with plasma coating, intermediate layers, as e.g. polymers as EVOH or nylon or the like, is also conceivable. Decisive thereby is the fact that the possible supply of oxygen via the plastic coating of the containers is avoided or at least reduced. The storage container can be configured in a self-standing manner, for example, by being configured with a petaloid base. For the simple assembly and for a simple transport, the storage container may comprise a screw plug and/or an ergonomic handle. The wall thickness of the outer wall may be selected depending on the used material and the acting deformation forces such that the storage container is deformable as desired without breaking. Thereby, the storage container may also have differently configured wall elements or wall sections. These wall elements or wall sections, for example, can differ by the used material and/or the wall thickness. Thus, e.g. a wall element to be deformed having a low wall thickness may be configured while the remaining wall of the storage container can be configured with a greater wall thickness or a more stable material. This way, the deformable part of the container may be pressed into the part that cannot be deformed until the same ideally abuts the other one. A non-drainable remaining amount of the accommodation volume, thus, can be avoided. In addition, the thereby drained containers can be stacked in a simple manner for disposal or recycling purposes. A possible form of such a storage container, for example, is a double cone or a double sphere, whereby one half is configured being deformable. Preferably, the opening in this case can be arranged at the half that cannot be deformed.

A plurality of alternative embodiments of the storage container is conceivable. For example, the storage container can be formed as folding bellows made of a deformable material, for example plastic, wherein the wall thickness in the area of the folds is reduced. The storage container can as well be configured tube-shaped, wherein the entire wall area except for the opening and a wall element possibly encompassing the opening is configured as being deformable. The term “deformable” here and in the entire description is to be understood with respect to the forces exerted by the deformation unit. Thus, also the wall elements made of metal, e.g. in the form of sheets, are conceivable. According to a special embodiment, the term “deformable” also comprises a variant according to which as described above, a part of the container wall is slid as rigid element vis-à-vis the remaining container wall, similar to a spraying device. The storage container can also be formed in the form of a sealed bag having a screw plug made of a simply deformable plastic, for example a PET foil which can be placed on top of each other after draining the storage container for disposal. The accommodation volume of the storage containers, for example, can be greater than or equal to 10 liters and smaller than or equal to 50 liters, preferably greater than or equal to 10 liters and smaller than or equal to 30 liters.

The above mentioned objects are also solved by a method for applying labels onto containers, wherein glue is removed from the storage container for storing glue and is applied to labels which is characterized in that the removing of glue occurs via pressing out the glue from the storage container by means of deforming the storage container.

The same variations and embodiments as described above in connection to the labeling device according to the invention, may also be applied to the method for labeling of containers. In particular, the removing of the glue from the storage container may occur without a glue pump as otherwise usual. The glue to be removed is pressed out of the storage container only by means of the internal pressure produced by deforming the storage container. In addition, as mentioned, the glue can be applied either directly onto the glue applying side of the labels or indirectly, by initially applying it onto a contact surface of a pallet at which the pallet subsequently accommodates the label to be applied with glue. For applying glue onto the contact surface of the pallet or the rear side of the label, as mentioned, a principally known glue roller or the above described controllable glue printer can be used. Consequently, applying glue can occur by means of unrolling the contact surface or the label rear side at the glue roller or by spraying glue by means of a glue printer onto contact surface or the label rear side. Regarding the latter mentioned, in particular a variable glue image can be applied by means of controlled activating and deactivating a plurality of individually or in groups controllable glue nozzles of the glue printer.

The method can furthermore comprise the feeding of the removed glue via a transport line to the glue roller or the glue printer as well as the applying of the removed glue onto an outer surface of the glue roller or the contact surface of a pallet or directly onto the glue applying surface of the label. Further method steps for transferring the glue to the label to be applied as well as for applying the label applied with glue onto the container to be applied with a label as they are principally known from the prior art and described above, may of course be also included.

According to an embodiment, deforming the storage container by means of such an application of the deformation unit to the storage container configured in a deformable manner may occur such that the accommodation volume of the storage container for glue is reduced. The application as described above, in particular, can be a mechanical action on the wall or on a part of the wall of the storage container. As mentioned, the application may also comprise the sliding of a part of the wall of the storage container into the accommodation volume of the storage container, similar to draining a spraying device. The above described embodiments of the storage container configured in a deformable manner as well as the deformation unit may also be used here. By reducing the accommodation volume, pressure is applied to the glue being located in the accommodation volume of the filled storage container which presses out the amount of glue to be removed from the opening of the storage container.

According to a special embodiment, the accommodation volume of the storage container can be reduced by means of a relative movement of at least one deformation element of the deformation unit and the storage container that can be brought into contact with the storage container. As already described, the at least one deformation element alone, the storage container alone or both simultaneously can be moved for effectuating this relative movement. Depending on the configuration and arrangement of the storage container and the deformation element, a plurality of different movements is conceivable. For example, a punch-shaped deformation can be moved relatively to the storage container so that it is initially brought into contact with the part of the wall of the storage container to be deformed for deforming this part with a further relative movement. Alternatively or additionally, the storage container can be moved relative to the deformation element. As mentioned, also sliding one wall element of the storage container by relatively moving the deformation element and/or the storage container corresponding to the draining of a spraying device is possible. Regarding tube-shaped storage containers, the relative movement can comprise pulling or pushing through the storage container between two rollers or wedge-shaped deformation elements or a corresponding movement of the deformation elements along the longitudinal axis of the storage container towards its opening. Finally, also a hose-shaped storage container is conceivable which is twisted due to rotation of a deformation element clamping the end of the hose opposed to the opening such that the glue is pressed out of the opening. The relative movement of the at least one deformation element and the storage container occurs between one starting position and one end position for each of the elements to be moved. Thereby, the starting position can be selected such that in this position, an exchange of the storage container is enabled, for example, by the fact that the deformation element in this position is spaced apart from the storage container. The end position can preferably be selected such that the storage container in this position is essentially drained entirely of glue.

The method according to the invention can also comprise the movement of the deformation element and/or the storage container in an idle position in which the labeling operation of the labeling device is suspended. With a suitable configuration of the storage container and/or the deformation unit, for example, by slightly retracting the deformation element or the storage container, it may be achieved that glue located in the transport line is pulled back into the storage container. This is in particular possible when linking the aforementioned connection from above with the opening of the storage container. Further, the deformation element can be configured such that it adheres to the wall element of the storage container to be deformed by, for example, being coated with an undercoating. Retracting the deformation element, thus, also pulls back the wall element so that a vacuum is produced in the accommodation volume of the storage container which pulls back the glue located in the transport line. In this way, it may be avoided that the glue touches dry in the transport line which is in particular important during starting the labeling device. The remaining glue may as well be pulled back in the transport line for the glue exchange into the storage container to be exchanged.

According to a further embodiment, the relative movement can be controlled and/or adjusted such that a desired amount of glue, in particular with the desired pressure is removed from the storage container. For this purpose, as described above, a controllable and/or adjustable drive unit can be provided for the relative movement. The control and/or adjustment, as mentioned, can occur by means of a programmable logic controlling and/or adjusting unit which may in particular comprise a type management for the containers to be labeled and the used labels. The control and/or adjustment of the relative movement allows in particular that exactly the required amount of glue is removed from the storage container and transferred to the glue roller or the glue printer. Thereby, touching dry or running down of surplus glue on the glue roller can be avoided. In addition, a return flow of the surplus glue can be dispensed with.

In particular, the control and/or adjustment as already outlined may occur on the basis of at least one control parameter from the group formed by the following parameters: the type of the labels to be applied with glue, the number of the labels to be applied with glue per time unit, the variety of the used glue, the temperature of the used glue, the ambient temperature of the glue roller or the glue printer and the surface of the labels to be applied with glue. In addition thereto, individual parameters as, for example, the type of the labels to be applied with glue, the variety of the used glue or the surface of the labels to be applied with glue can be adjusted by an operator of the labeling device via an input unit of the control and adjustment unit or can be read out according to the selection of the product to be labeled from a storage unit of the control and/or adjustment unit. Other parameters as, for example, the number of the labels to be applied with glue per time unit, the temperature of the used glue or the ambient temperature of the glue roller or the glue printer can be determined via corresponding sensors of the control and/or adjustment unit and used for controlling the relative movement.

According to an embodiment, the method can further comprise stabilizing in a part of an outer surface of the storage container by means of bringing into contact said part with a housing of the deformation unit for accommodating the storage container. Said bringing into contact in the simplest case can occur during inserting the storage container into the deformation unit. On the other hand, the housing can also be brought into contact with the corresponding part of the outer wall of the storage container by means of a respective drive unit as part of the deformation process. Thus, the housing may in particular be provided as counterpart to the deformation element. As described above, the housing and the part of the outer surface of the storage container can be formed such that the housing encompasses said part of the outer wall of the storage container. Therefore, the housing acts in a stabilizing manner to the part of the outer wall encompassed by it and, thus, prevents the outer wall from bursting or breaking and which therefore may be fabricated with a lower wall thickness or of a cost-effective material. The above described embodiments of the housing are used here, as well. Stabilizing the part of the outer surface thereby is to be understood such that this part of the outer wall maintains its form during the deformation process due to its contact with the housing.

According to an embodiment, the method may further comprise heating and/or cooling the storage container. As described above, this heating and/or cooling may occur directly via a contact heating or cooling or indirectly via heating and/or cooling the air ambient to the storage container. For example, the storage container for the latter variant may be placed within an enclosure entirely encompassing the storage container and optionally the deformation unit. In addition to heating and/or cooling the storage container, also the transport lines for the glue and/or the glue applying unit may be heated and/or cooled. Heating and/or cooling may in particular occur such that the glue is always kept at the optimal working temperature.

The above described embodiments allow the exactly required amount of glue to be removed from the storage container and applied onto the glue roller, the label or the pallet. Thereby, in particular, it can be dispensed with high-maintenance glue pumps. In addition, in a simple manner, an exchangeable storage container in the form of a non-returnable container can be used, due to which also the cleaning of the storage container, in particular during a glue change, is omitted. Due to a specific control of the glue removal, moreover, different operation states, as e.g. a labeling mode, an idle mode, and a cleaning mode, can be adjusted. Since no surplus glue is applied, it can furthermore completely dispensed with a return flow.

Further features and exemplary embodiments as well as advantages of the present invention are explained in the following in more detail by means of the drawings. It is clear that the embodiments do not exhaust the scope of the present invention. It is further clear that some or all of the features described in the following may also be combined in any other way with one another.

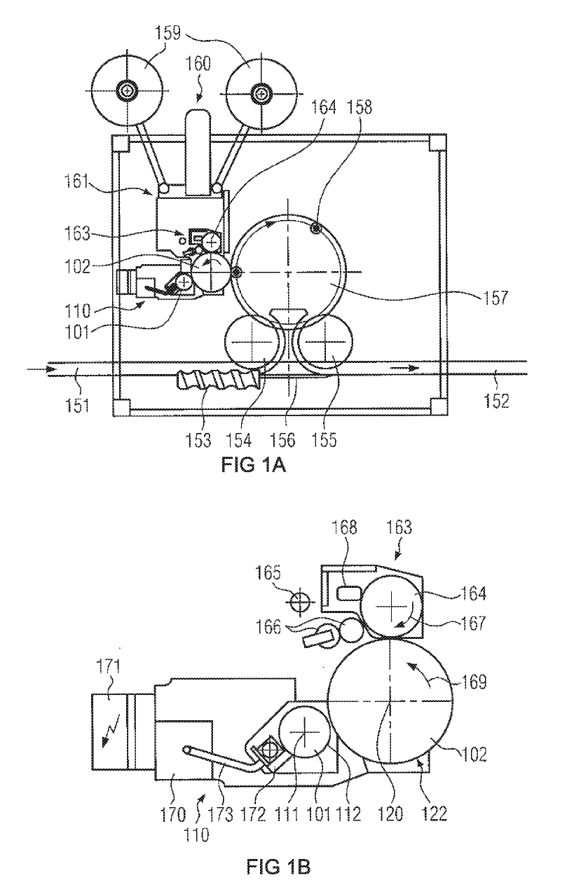

FIG. 1a shows a schematic top view of a labeling device according to which the glue is applied directly from the glue roller to the labels.

FIG. 1b shows the gluing unit of FIG. 1a in a detailed view.

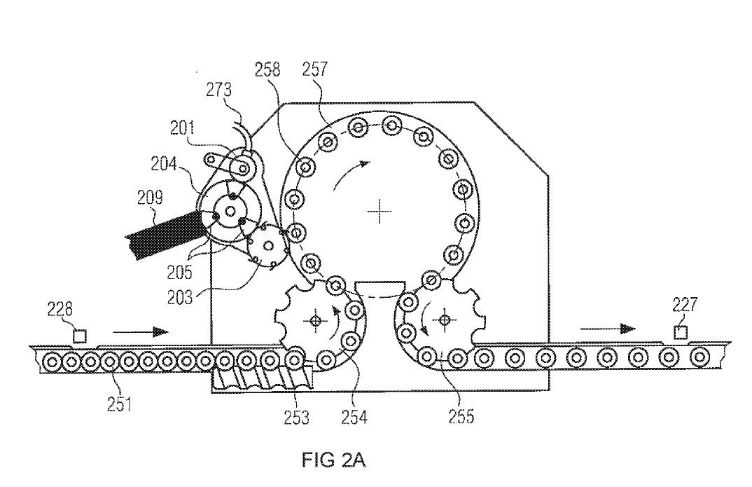

FIG. 2a shows a schematic top view of a labeling device according to which the glue is applied via a pallet carousel to the labels.

FIG. 2b shows the gluing unit of FIG. 2a in a detailed view.

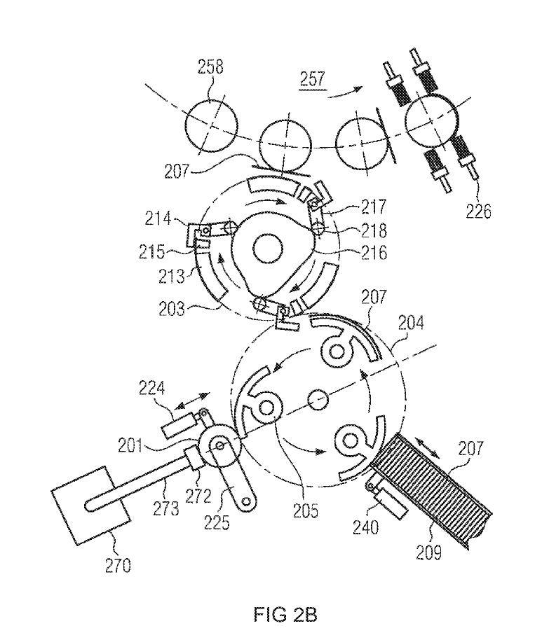

FIG. 3 shows a schematic sectional view of a device for removing glue according to the present invention

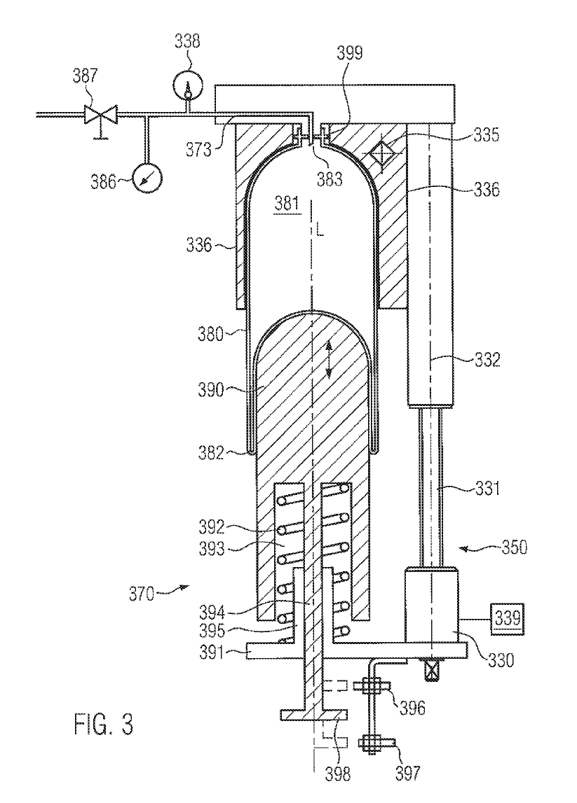

FIG. 4 shows the deformation of the storage container according to the present invention in two exemplary phases.

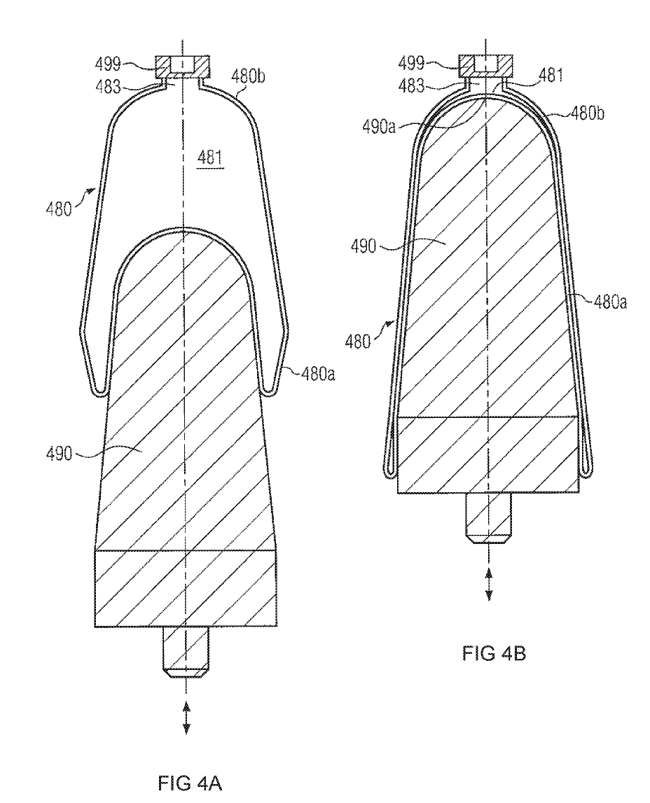

FIG. 5 shows a plurality of embodiments of deformable storage containers for glue according to the present invention.

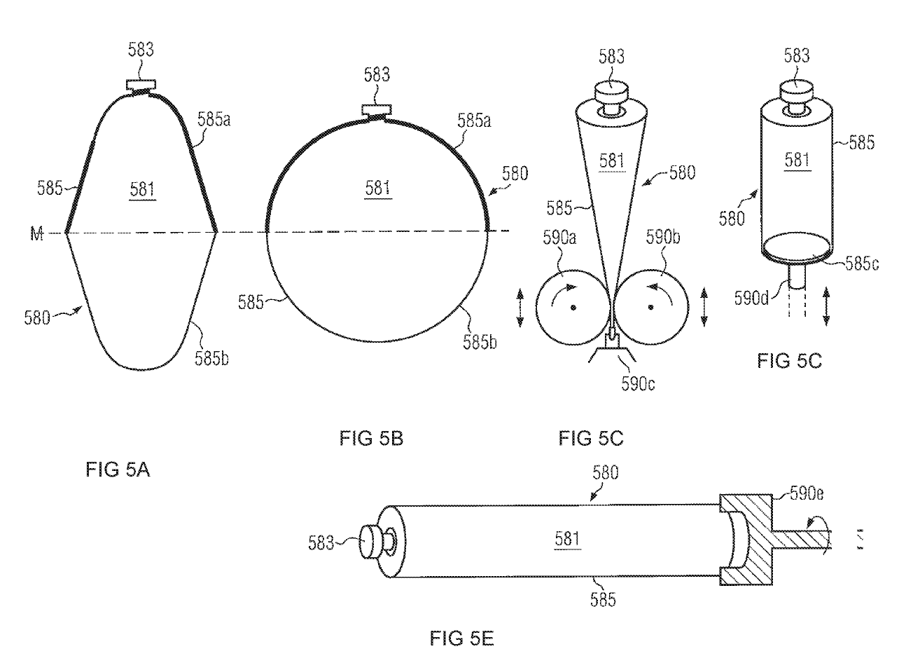

FIG. 6 shows a modular embodiment of the removing device according to the present invention in a cabinet-like enclosure.

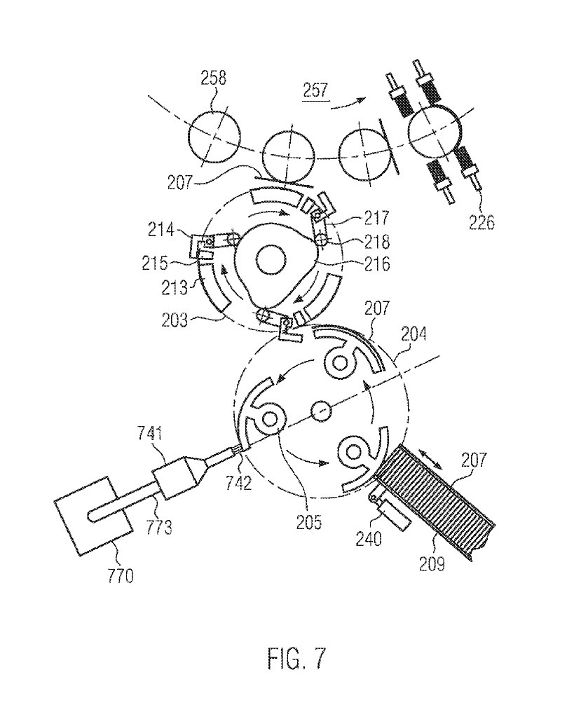

FIG. 7 shows an alternative embodiment according to the present invention with a glue printer instead of a glue roller.

In the following, the same or similar elements are identified with the same reference signs. For clarity reasons, it is dispensed with a repeated description of these elements. In addition, it is clear that in the following embodiments some or all elements can be replaced by or combined with similar elements which are described in connection with other embodiments.

FIG. 1a shows a schematic top view of a labeling device according to which the glue is applied directly from the glue roller to the labels. The gluing unit of FIG. 1a is shown in a detailed view in FIG. 1b. The shown labeling device has the following elements principally known from the prior art: a supply conveyor 151 for the continuous supply of the containers to be labeled, an infeed star wheel 154 with an upstream infeed worm 153, a guide bend 156, a carousel 157 with a plurality of rotary plates 158 evenly placed on a joint pitch circle, a discharge star wheel 155 and a discharge conveyor 152 for discharging the labeled containers. In the circulation area between the infeed star wheel 154 and the discharge star wheel 155, at the outer periphery of the carousel 157, there is located a labeling unit 161 for applying the labels onto the containers. The labeling unit 161 exemplarily shown here has two label roll capacities 159 and a splicing station 160 lying in between, a cutting unit 163, and a gluing unit 110 with a vacuum cylinder 102 for transferring the pre-sliced, glued labels to the passing containers.

The labeling process of one container occurs in detail as follows: the containers generally butt-conveyed by the supply conveyor 151 are moved apart from the laterally arranged infeed worm 153 on the division of the infeed star wheel 154 so that this can transfer the accommodated containers in cooperation with the opposing guide bend 156 onto the rotary plates of the rotating carousel 157. There, the containers are clamped by centering bells (not shown) and are tangentially guided past the vacuum cylinder 102 of the labeling unit 110 by the rotating movement of the carousel 157. Simultaneously, from a label roll capacity 159 a label roll is controllably removed and sliced into individual labels in the cutting unit 163. The separated labels which are located with the print image pointing outwards on the rotating vacuum roll 164 during the cutting process are transferred to the vacuum cylinder 102 after the cutting process from where they are guided past the glue roller 101 with the rear side pointing outwards and are provided with glue in a certain area of the label depending on the label type. The labels applied with glue are tangentially fed to the carousel 157 on which the containers are located. The labels to be applied are thereby with the application of glue brought into contact with the containers and are unrolled to the same by means of a suitable movement. After passing the labeling unit 110 and after completion of applying the label onto the container, the labeled container is transferred to the discharge conveyor 152 by the discharge star wheel 155.

In the detail view of FIG. 1b, in addition to the cutting unit 110, the cutting unit 163 can be seen. The label roll removed from the label roll capacity 159 is supplied to the cutting unit 163 via a return pulley 165 and the roll pair 166. There, the label roll abuts the vacuum roller 164 which rotates in the direction of the arrow 167 and is cut by a separation element 168 pursuant to the cutting marks or the print image. The sliced labels are transferred to the vacuum cylinder 102 which rotates in the direction of the arrow 169. The labels, thus, abut the shell surface 122 of the vacuum cylinder 102 which rotates about the axis 120. The shell surface 122 of the vacuum cylinder 102 comprises elements (not shown) accommodating the beginning or the end of the label, respectively. For accommodating different label lengths, the vacuum cylinder can be exchanged.

When moving the labels past the glue roller 101, the individual areas or the entire rear side of the labels are brought into contact with the glue roller so that they are provided with glue at certain positions. The amount of the transferred glue thereby depends on the label type and the areas to be applied with glue. In order to be able to provide a label with glue, a gluing unit 110 is required. The gluing unit 110 shown in FIG. 1b is configured without glue pump according to the present invention. By a device 170 which is heatable by means of an optional glue heater 171 for removing glue from the storage container for storing glue, the removed glue is guided via a transport line 173 to a glue application unit 172 which is schematically shown here, and is by means of this transferred to the shell surface 112 of the glue roller 101 rotating about the glue roller axis 111. The glue application unit 172 thereby can comprise a glue strip which is located so close to the glue roller 101 that it removes the surplus glue from the shell surface 112. When using the device according to the invention for removing glue, however, this glue strip can be omitted since a return flow is not required anymore.

FIG. 2a shows a schematic top view of an alternative labeling device according to which the glue is applied via a pallet carousel to the labels. A detail view of the gluing unit of FIG. 2a is not shown in FIG. 2b. On a rotating carrier 204 of the carousel several removing elements 205, so-called pallets are rotatably arranged. When the pallet carousel is rotated, the accommodating surface of each removing element 205 rolls off the glued surface of the glue roller 201, removes a label 207 from the label container 209 by means of adhesion, whereby this is applied with glue on the rear side, and transmits it to the gripper cylinder 203 that transfers it to the containers. These were supplied beforehand in an infeed flow 251 of an infeed worm 253 which produces the separation required for the infeed star wheel 254. Along the infeed flow 151, moreover, a sensor for determining a flow capacity at containers to be labeled may be arranged. From the infeed star wheel 254, the containers to be labeled are transferred to the rotating plates 258 of a carousel 257 which guides the containers past the gripper cylinder 203. Also here, by means of suitable rotating of the containers accommodated by the rotating plates 258, unrolling of the label to be applied supplied by the gripper cylinder 203 is effectuated on the surface of the container. The label applied to the container may subsequently be pressed on the container by means of brushes 226. The labeled containers are finally transmitted to a discharge flow via a discharge star wheel 255 where an optical sensor 227 can carry out a quality control of the labeled containers.

Further details of the labeling unit are shown in FIG. 2b. For example, the label container 209 may be switched on the pallet carousel 204 via a pneumatic cylinder 240 in the labeling mode and can be switched off by the same in the idle mode. The pallets 205 of the pallet carousel 204 may be pivoted by a control curve (not shown) such that they are applied with glue by the glue roller 201 and subsequently accommodate one label 207 each from the label container 209. The glue roller 201 can be mounted at a pivoting support 225 by means of a pneumatic cylinder 224, whereby it can be switched on to the pallet carousel 204 in the labeling mode and switched off the same in the idle mode. Via the transport line 273, the glue from the storage container (not shown) removed by the removing unit 270 is supplied to a glue application unit 272 which is schematically shown here, for example in the form of a chamber glue scraper, which transfers the glue to the surface of the glue roller 201. The labels 207 removed by the pallets 205 from the label container 209 are transferred to the gripper cylinder 203. This takes over the respective label 207 by means of a gripper finger 214 and an anvil 215 from the pallet 205, wherein the glued side of the label 207 is placed on gripper sponge 213. The movement of the gripper fingers 214 mounted on gripper arms 216 is thereby effectuated due to the unrolling of the gripper rolls 218 which are also mounted on the gripper arms 217 onto a control curve 216 of the gripper cylinder 203. For transferring the labels 207 to the containers, the gripper fingers 217 are newly opened.

FIG. 3 shows a cross section through a schematic view of a device 370 for removing glue according to the present invention. According to the invention, the removal of glue occurs from a deformable storage container 380 by applying a deformation unit 350 to the storage container, whereby its accommodation volume 381 for glue is reduced. The pressure thereby produced in the glue presses out the glue amount to be removed through an opening 383 of the container.

In the not limiting embodiment shown here, deforming the storage container 380 occurs by direct mechanically applying of a deformation element 390 to the wall of the storage container. For this, the deformation element 390 in this embodiment is movable by means of a motor 330 which actuates a shaft 331 that engages a stationary corresponding counter thread 332, relative to the storage container 380 along the longitudinal direction L. The motor 330 may be configured controllably and/or adjustably so that this relative movement can be controlled and/or adjusted by means of a control and/or adjustment unit 339. In the embodiment shown in the Figure, the part of the removing unit 370 supporting the storage container 380 is fixed in place, while the deformation element 390 moves relatively thereto. It is clear that the arrangement can be modified such that the storage container can be moved alternatively or additionally to the deformation element.

The storage container 380 is linked to a connection 399 of the device with its opening 383, for example, via a screw thread. Due to this screw thread, a drained storage container may thus be exchanged in a simple manner by a filled storage container. Via the opening 383 and the connection 399, the pressed out glue is passed on a transport line 373 which, as described above, further supplies it to the glue roller or a glue printer. Thereby, the transport line may have a control valve 387 for a precise control of the discharged glue amount. Further, a pressure sensor 386 and/or a temperature sensor 338 may be provided measuring the pressure or the temperature of the glue in the transport line 373. The measured data may be transmitted to the control and/or adjustment unit 339 and can, thus, be integrated in the control and/or adjustment of the motor 330 of the drive unit.

In the embodiment shown here, the deformation element 390 is mounted on a carrier 391, wherein between the deformation element and the carrier, there is provided a spring 392 which pretensions the deformation element vis-à-vis the carrier. The shown spring 392, thereby, is arranged in a recess 393 of the deformation element 390. Furthermore, the deformation element 390 comprises a bar 394 which is guided in a guide 395 of the carrier 391. At the carrier 391, in this embodiment there are arranged two sensors 396 and 397 which detect a position of a protrusion 398 arranged at the bar 394. Depending on signals transmitted from these sensors which, for example, may be light barriers or magnetically working sensors, a movement of the carrier 391 can be controlled such that the protrusion 398 is always located between the two sensors 396 and 397. In this manner, a predetermined force of the spring 392 can be adjusted on the deformation element 390 and, thus, also a predetermined pressure on the glue located in the storage container 380. Therefore, an excessive pressure which could lead to a break of the container wall may be effectively avoided.

By relative sliding the deformation element 390 along the longitudinal direction L, the surface of the deformation element which is a reproduction of the form of the upper part of the storage container 380 can initially be brought into mechanical contact with the lower part of the storage container and then, by means of a further sliding, can be slid into the same. Thereby, the storage container is deformed such that the lower part of its wall is pushed into the accommodation volume 381 so that a bent edge 382 of the deformed storage container 380 occurs. By increasing sliding of the deformation element 390, the wall of the storage container is more and more pushed into the interior of the storage container. Thereby, nearly the entire glue contained in the storage container is by and by pressed out of the same. The form of the storage container 380 and the deformation element 390 may be thereby selected such that during the deformation process, there are occurring as few gaps as possible for glue. Accordingly, a punch-shaped deformation element, as shown here, can be formed with a slightly smaller cross-sectional area than that of the storage container in order to be able to be pushed into the same.

The wall or at least the part of the wall of the storage container 380 to be deformed are formed of a material which can be deformed by the force applied by the deformation unit 350, for example PET, in a corresponding wall thickness. Thereby, the different regions of the wall can be formed of different materials and/or with different wall thicknesses. It is in particular desirable that the upper part of the storage container 380 which is not to be deformed does not deform and bulge in the illustrated embodiment since otherwise a complete draining of the storage container and a controlled glue pressure cannot be guaranteed. For stabilizing the part of the wall of the storage container 380 which is not to be deformed, the deformation device shown here comprises a housing 336 for accommodating this part of the container which is brought into contact with an outer surface of the part of the container which is not to be deformed such that it encompasses this part in a sleeve-like manner. The part of the container wall being in direct mechanical contact with the housing 336, thus, cannot be bulged by the increasing pressure in the accommodation volume 381. In addition, the housing 336 can be provided with a controllable heating and/or cooling device 335 allowing to heat or cool the glue located in the accommodation volume 381 to an optimal working temperature. The control of the heating and/or cooling device 335 thereby can occur by considering the glue temperature measured by the temperature sensor 338.

A plurality of alternative embodiments of the removing device 370 is conceivable. For example, the deformation element 390 can be configured fixedly, while the storage container 380 is moved by the drive unit 330. In addition, the connection 399 for the opening 383 can be arranged below the storage container 380. It also conceivable to configure the connection 399 and a part of the transport line 373 as part of the deformation element 390, wherein the transport line 373 in case of a moved deformation element 390 preferably comprises at least one flexible part. Form and type of the deformation unit 350 can further be adapted to the forms of the storage containers as described below.

FIG. 4 shows the deformation of the storage container according to the present invention in two exemplary phases. In part Figure a), the initially double conical storage container 480 had been already deformed by the deformation element 490 to an extent that the accommodation volume 481 for glue inside the storage container 480 was reduced to less than half the amount. Thereby, a majority of the glue originally contained in the storage container had already been pressed out of through the opening 483 and the connection 499. As can be taken from the part Figure, the deformation element 490 due to the deformation process presses a part of the wall 480a of the storage container by into the interior of the storage container. Thereby, the curved upper part of the deformation element 490 is formed such that is has exactly the form of the upper part 480b of the container wall. In particular, the deformation element 490, as already repeatedly mentioned, is configured such that it exactly fits into the part of the storage container not to be deformed, wherein the thickness of the container wall pushed into the interior is also considered.

In part Figure b) of FIG. 4, the deformation process is completed. The entire lower cone of the storage container 480 was pushed into the interior of the storage container such that the wall elements of the lower and the upper part are essentially placed on one another. Thus, the accommodation volume 481 was nearly reduced to zero so that the glue originally contained in the storage container had been nearly entirely removed therefrom. The deformation element 490 can now be backed to its starting position for exchanging the drained storage container 480, wherein the storage container 480 keeps its deformed end shape. In this manner, the drained storage containers can be stacked for disposal or recycling purposes in a space-saving manner.

FIG. 5 shows a plurality of embodiments of deformable storage containers for glue according to the present invention. In part Figure a), also the form of the double cone is shown for the storage container 580 according to the invention as shown in FIGS. 3 and 4. As in the other part Figures, the container is schematically illustrated, wherein the container wall 585, the accommodation volume 581, and the opening 853 of the container are explicitly identified. In part Figures a) and b), in addition, a center line M of the containers is shown. The part 585b of the container wall shown below this center line M is pushed into the part 585a of the container wall shown above the center line M due to the deformation process. In the not limiting embodiment shown in part Figures a) and b), the part 585a of the container wall 585 not to be deformed is configured with a greater wall thickness than the part 585b to be deformed. Thereby, it can be avoided that the wall element 585a, i.e. the part 585a of the container wall, counteracts due to the deformation to the increase of the internal pressure in the accommodation volume 581. Alternatively thereto, the part 585a not to be deformed can also be formed of a different, more stable material than the part 585b to be deformed. In addition to the forms of the double cone and the sphere, a plurality of alternative forms is conceivable, e.g. an ellipsoid or a double pyramid.

In part Figure c), an alternative embodiment of the storage container 580 in the form of a tube is shown. Thereby, the tube can be clamped with its narrow end between two pivoted rollers 590a and 590b which are either configured freely rotatable or drivable. In the latter case, the surface of the rollers may be configured with a sufficiently high friction coefficient for pulling through the surface of the outer wall 585 during the deformation process between the rollers. Alternatively or additionally, the narrow end of the tube can be clamped at an element 590c which is movable along the longitudinal direction of the tube which pulls through the tube between the two rollers. Since the rollers 590a and 590b are mounted at a stationary axis, the accommodation volume 581 of the storage container 580 is reduced by this pulling through so that glue is pressed out through the opening 583. The walls 590a and 590b may as well be movably configured in the longitudinal direction of the tube, wherein deforming the storage container 580 occurs by means of sliding the rollers, in this case also non-rotatably configurable, along the longitudinal direction. Instead of the rollers, also wedge-shaped elements can be used. The sliding and/or rotating of the rollers 590a and 590b as well as the sliding of the clamp element 590c can occur by means of the mentioned control and/or adjustment unit by controlling and/or adjusting.

In part Figure d), a further alternative embodiment of the storage container 580 in form of a spraying device is shown. Here, a cylindrical part of the container wall can be configured rigidly, wherein the reduction of the accommodation volume 581 occurs by sliding of a base element 585c of the storage container which is also configured rigidly. As mentioned above, also this sliding results in a deformation of the storage container in the meaning of the present invention. At the base piece 585c, for this purpose, a bar-shaped deformation element 590d actuates which is moved by means of a controllable and/or adjustable drive unit.

In part Figure e), finally, a hose-shaped storage container 580 is shown the end of which opposing the opening 583 is clamped by a clamping element 590e of the deformation unit. In the embodiment shown here, the relative movement of the deformation element and the storage container occurs by means of rotating the deformation element 590e. Thereby, the hose-shaped storage container 580 which in particular can be formed of a thin plastic foil, is twisted so that the contained glue is pressed out of the opening 583. Also regarding this embodiment, the amount of the drained storage container is minimized.

FIG. 6 finally shows a modular embodiment of the removing device according to the present invention in a cabinet-like enclosure. In this embodiment, the deformation unit from which here only the deformation element 690 and the drive unit 630 are schematically shown, and the storage container 680 which in this Figure is already partly deformed with accommodation volume 681 and completely encompassed by a cabinet-like enclosure 637 which in this Figure exemplarily is placed on wheels. The storage container 680 is linked with a transport line 673 for the glue to be removed via a connection 699. A part of this transport line can be fixedly connected to the enclosure 637 and provided with a connecting piece for connecting the corresponding glue line of the labeling unit. In this manner, the removing module for existing labeling machines can be easily refitted.

The removing module in FIG. 6 is shown in the opened state for exchanging the storage container 680. For this purpose, the cabinet-like enclosure 637 may be provided with the cabinet-like enclosure 637 foldable or movable door units (not shown) which can be opened and closed as required. Seals at the door units may ensure that the enclosure 637 is essentially hermetic in the closed state, i.e. within manufacturing tolerances. Thereby, in the interior of the sealed enclosure 637, a well-defined environment of the removing device is established which can be tempered by means of a controllable and/or adjustable heating and/or cooling device 635 of the module to an optimal working temperature of the used glue. Further, the module can comprise an own control and/or adjustment unit or can be connected to a control and/or adjustment unit of the labeling device.

In FIG. 7, an alternative embodiment of the labeling device shown in FIG. 2b is shown, wherein instead of the glue roller 201, a controllable glue printer 741 is used for printing a variable print image on the contact surface of the pallet 205. Therefore, the glue printer 741 comprises one or more, in particular individually controllable glue nozzles which are arranged with regard to a circumferential path of the pallet 205 regarding their pivoting movement such that the glue jet 742 emitted from the nozzles impinge the contact surface of the pallet 205. In order to achieve a desired glue image on the pallet 205 which, for example, corresponds to the form and/or size of the label 207 to be applied with glue, the glue nozzles of the glue printer 741 may individually or in groups be activated or deactivated via a control and/or adjustment unit of the labeling device. Due to the pivoting movement of the pallet 205, thereby, a two-dimensional applying of glue occurs with a glue pattern predetermined by the control parameters. Similar to the glue application unit 272, the glue printer 741 can be provided precisely with the required amount of glue via a transport line 773 by deforming the storage container by means of the removing unit 770. The glue pressure established thereby may at least partly be used for operating the glue nozzles. If a higher glue pressure is required, a glue pump or a pressure booster pump with a possible media pressure of 30 to 90 bar can be provided. An additional use of a speed mixer or a twin-screw extruder that vents and mixes the glue once more, is also conceivable.

The described embodiments allow to remove exactly as much glue from a deformable storage container as required for applying glue to the labels to be applied. Thereby, touching dry or running down of surplus glue on the glue roller can be avoided so that an otherwise usual return flow of the surplus glue can be dispensed with. Since the glue in addition hardly comes into contact with the ambient air, the desired glue characteristics can be guaranteed. The use of compressible, exchangeable non-returnable containers as storage containers in addition allows a proper and simple operation of the labeling device without major maintenance efforts and with a long service life. Also the disposal or recycling of the drained containers is simplified by their low capacity amount.

1. A labeling device for applying labels onto containers, comprising:
a gluing unit for applying glue to the labels,
a storage container for storing the glue, and
a device for removing the glue from the storage container comprising a deformation unit which is designed such that the glue is pressed out of the storage container by deforming the storage container by means of the deformation device.

2. The labeling device according to claim 1, wherein the deformation unit is configured such that by application of the deformation unit to the storage container, the accommodation volume of the storage container for glue is reduced.

3. The labeling device according to claim 2, wherein the deformation unit comprises at least one deformation element, which can be brought into contact with the storage container, and where the deformation unit is configured such that the storage container and the deformation element are movable relative to one another, wherein by a relative movement of the deformation element and the storage container, the accommodation volume of the storage container for glue is reduced.

4. The labeling device according to claim 3, wherein the deformation unit comprises a controllable and/or adjustable drive unit which effectuates a movement of the deformation element and/or the storage container.

5. The labeling device according to claim 4, wherein the deformation unit further comprises a programmable logic controlling and/or adjusting unit which is configured to control and/or to adjust the drive unit depending on at least one control parameter from the group formed of the following parameters: a type of the labels to be applied with the glue, a number of the labels to be applied with the glue per time unit, a variety of the glue, a temperature of the glue, an ambient temperature of a glue roller, and a surface of the labels to be applied with the glue.

6. The labeling device according to claim 1, further comprising a housing for accommodating the storage container, wherein the housing is formed such that it encompasses a part of an outer surface of the storage container in a sleeve-like manner.

7. The labeling device according to claim 1, further comprising a heating device and/or a cooling device which is configured such that the storage container is heated and/or cooled.

8. The labeling device according to claim 7 further comprising an enclosure which is arranged such that it entirely encompasses the deformation device and the storage container.

9. A storage container for use in a labeling device that is for applying labels onto containers, the labeling device comprising a gluing unit for applying glue to the labels, a storage container for storing the glue, and a device for removing the glue from the storage container comprising a deformation unit which is designed such that the glue is pressed out of the storage container by deforming the storage container by means of the deformation device,
wherein
the storage container is configured such that it is deformable by application of the deformation unit.

10. A method for labeling containers, comprising:
removing glue from a storage container for storing the glue,
applying the glue to labels, and
removing the glue via pressing out the glue from the storage container by means of deforming the storage container.

11. The method according to claim 10, wherein the deformation of the storage container occurs by means of application of a deformation unit to the storage container, where the storage container is configured in a deformable manner, and where the deformation unit is applied in such a way that an accommodation volume of the storage container for the glue is reduced.

12. The method according to claim 11, wherein the accommodation volume of the storage container is reduced by means of a relative movement of the storage container and at least one deformation element of the deformation unit which is brought into contact with the storage container.

13. The method according to claim 12, wherein the relative movement is controlled and/or adjusted such that a desired amount of the glue is removed from the storage container.

14. The method according to claim 13, wherein the control and/or adjustment occurs on the basis of at least one control parameter from the group which is formed of the following parameters: a type of the labels to be applied with the glue, a number of the labels to be applied with the glue per time unit, a variety of the glue, a temperature of the glue, an ambient temperature of a glue roller, and a surface of the labels to be applied with the glue.

15. The method according to one of the claim 11, further comprising stabilizing a part of an outer surface of the storage container by bringing the part into contact with a housing of the deformation unit for accommodating the storage container.

16. The method according to claim 10, further comprising heating and/or cooling of the storage container.

17. The labeling device according to claim 1, where the glue is applied to the labels with a glue roller.

17. The method according to claim 13, where the relative movement is controlled and/or adjusted such that the glue is removed with a desired pressure from the storage container.

18. A storage container for use in the a labeling device that is for applying labels onto containers, wherein the storage container is configured such that it is deformable by application of the deformation unit.
